(19) United States
(12) Patent Application Publication
(10) Pub. No.: US 2007/0050750 A1
(43) Pub. Date: Mar. 1, 2007

(54) Extensible data-driven setup application for operating system

(75) Inventors: Sergey I. Bykov, Redmond, WA (US); Craig A. Jensen, Sammamish, WA (US); Harlan Husmann, Woodinville, WA (US); Charles J. Williams, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/217,635

(22) Filed: Aug. 31, 2005

(51) Int. Cl. G06F 9/44; G06F 9/445

(52) U.S. Cl. 717/100; 717/174

(57) ABSTRACT

An extensible data-driven setup application is provided for installing operating systems. Instead of performing installation operations itself, the host application determines individual tasks from a configuration file. The host application then instantiates and calls modules that perform the specific installation tasks including user interface screens, setup actions, data imports, and the like as defined in the configuration file. The modules are combined in module assemblies. The configuration file and the module assemblies may be customized for different sets of setup tasks, sequences of tasks, and content.

### BACKGROUND

Installation of an operating system is a complex task that involves many steps and actions. For example, the installation may include actions such as accepting a license agreement; partitioning and formatting of hard drives; copying compressed operating system files; decompressing copied files; detecting hardware and driver configurations; setting regional and language options, and the like.

Not all operating system installations may perform the same steps in different scenarios. Installations of different systems may require some steps specific for one operating system and not for the other. Additionally, mass manufacturers, who deliver computing devices with pre-installed systems, may desire to customize operating system setup processes by adding their own user interface screens and actions.

### SUMMARY

An extensible data-driven setup application is arranged to facilitate an installation of an operating system. The host application determines individual tasks associated with the installation. For each task identified in a configuration file, the host application instantiates and calls modules that perform the specific tasks. The modules may include screen modules for providing user interface screens, action modules for performing setup actions, and import modules for importing data from unattended files. The modules may be combined in module assemblies according to their categories and whether or not they are to be customized.

The configuration file and the module assemblies may be customized for different sets of setup tasks, sequences of tasks, and content. The host application may provide some information such as properties for screens to the modules as well as perform some of the tasks itself.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a computing device in which an operating system installation application according to an example aspect may be executed;

FIG. 2 illustrates example systems, where example aspects may be implemented;

FIG. 3 is a conceptual diagram illustrating interactions between different software components for installation of an operating system;

FIG. 4 illustrates interactions between a configuration file, a host application, and module assemblies during an installation of an operating system;

FIG. 5 illustrates different states and actions during an installation of an operating system; and

FIG. 6 illustrates a logic flow diagram for a process of installing an operating system.

### DETAILED DESCRIPTION

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

The terms “setup” and “installation” refer to loading and configuring of an operating system in a computing device and are used interchangeably throughout this specification.

Most computing devices require an operating system. While operating systems are installed in a relatively standard manner, different users may desire to customize the installation process. For example, parties that install operating systems en-mass to large numbers of computing devices, enterprise system administrators, and the like, may want to skip the steps of entering serial numbers, license agreements, etc. Some installers may include a predetermined set of applications in the operating system installation.

Furthermore, OEM manufacturers may want to customize user interfaces to reflect their product designs and fit the installation process to their needs. Accordingly, operating system installation may be performed in a variety of environments that may benefit from the ability to customize and reconfigure the process.

Installing variations of the same operating system or different but similar operating systems may require same or similar steps in the installation process. Reusing installation modules for multiple operating systems may reduce a cost of building a setup solution.

Illustrative Operating Environment

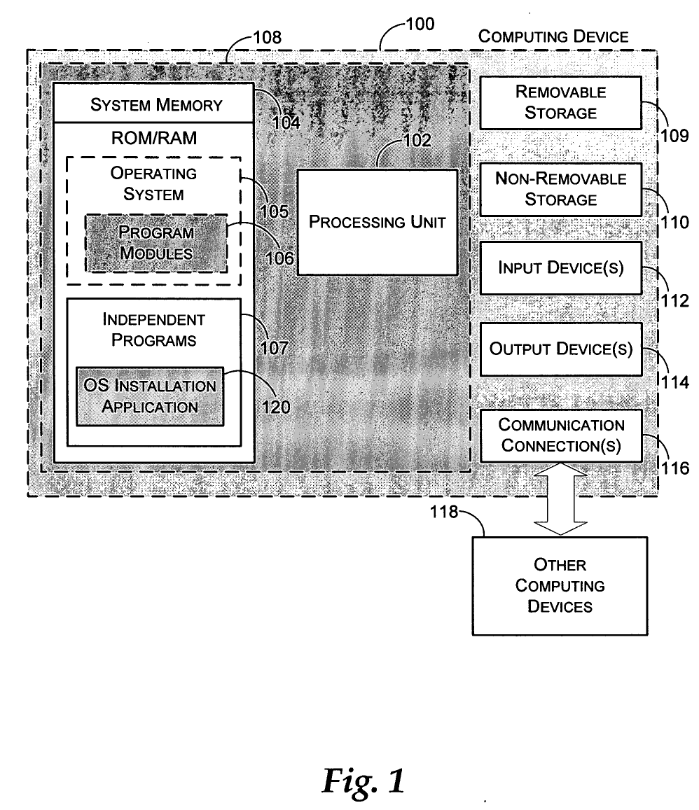

Referring to FIG. 1, an exemplary system for implementing some embodiments includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes operating system 105, one or more program modules 106 working within operating system 105. In addition to operating system 105 and programs running in operating system 105, independent programs 107 may also reside in system memory 104.

Independent programs 107 may include programs that run without the operating system being activated, before the operating system is installed, and the like. Independent programs 107 may include operating system installation application 120. This basic configuration is illustrated in FIG. 1 by those components within dashed line 108.

In one embodiment, operating system installation application 120 may facilitate installation of operating system 105 by using a configuration file and custom modules prepared by device manufacturers. Operating system installation application 120 may interact with other computing devices through communication connection(s) 116.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 1 10. Computer storage media may include volatile and nonvolatile, removable and non-removable media implemented in any method or technology for storage of information, such as computer readable instructions, data structures, program modules, or other data.

System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as retail devices, keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connections 116 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

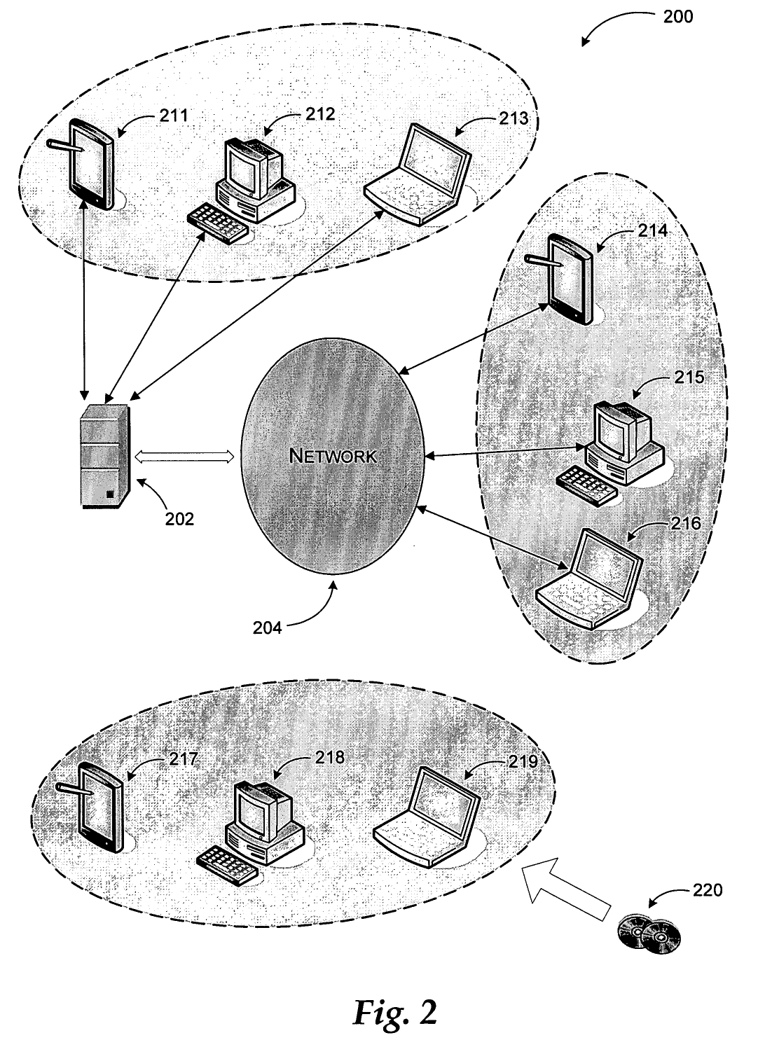

FIG. 2 illustrates example systems 200, where example embodiments may be implemented. Systems 200 may include networks that comprise any topology of servers, clients, Internet service providers, and communication media. The networks may also have a static or dynamic topology.

An operating system installation application may be loaded to other computing devices from server 202 over network 204. Server 202 may include a number of other applications such as hard drive imagers, test applications, configuration applications, performance measurement applications, and the like.

Computing device receiving the operating system installation application may include any type of computing device including, but not limited to, handheld computer 214, desktop computer 215, and laptop computer 216.

In another embodiment, server 202 may load the operating system installation application to computing devices 211 through 213 via direct communication such as serial connection, infrared connection, and the like. In a mass production environment, server 202 may load the application to a large number of computing devices automatically. In a further embodiment, the application may be loaded to one or more computing devices upon request.

Network 204 may be a secure network such an enterprise network, or an unsecure network such as an open wireless network. Network 204 provides communication between the nodes described above. By way of example, and not limitation, network 204 may include wired media such as a wired network or direct-wired connection, and wireless media such as acoustic, RF, infrared and other wireless media.

In one embodiment, the operating system installation application may be stored in computer-readable media such as CD-ROMs, DVDs, flash memory modules, and the like, and loaded to computing devices (e.g. computing devices 217-219) individually by inserting the storage medium into the hardware.

The present invention is not limited to the above-described environment, however. Many other configurations of computing devices, communications, applications, and distribution systems may be employed to implement an operating system installation application.

Illustrative Embodiments for an Extensible Data-Driven Setup Application for Operating Systems

Embodiments are related to providing an extensible data-driven setup application for operating systems such that the installation process can be easily reconfigured to perform different sequences of setup actions for different computing devices, operating system configurations, hardware configurations, and the like.

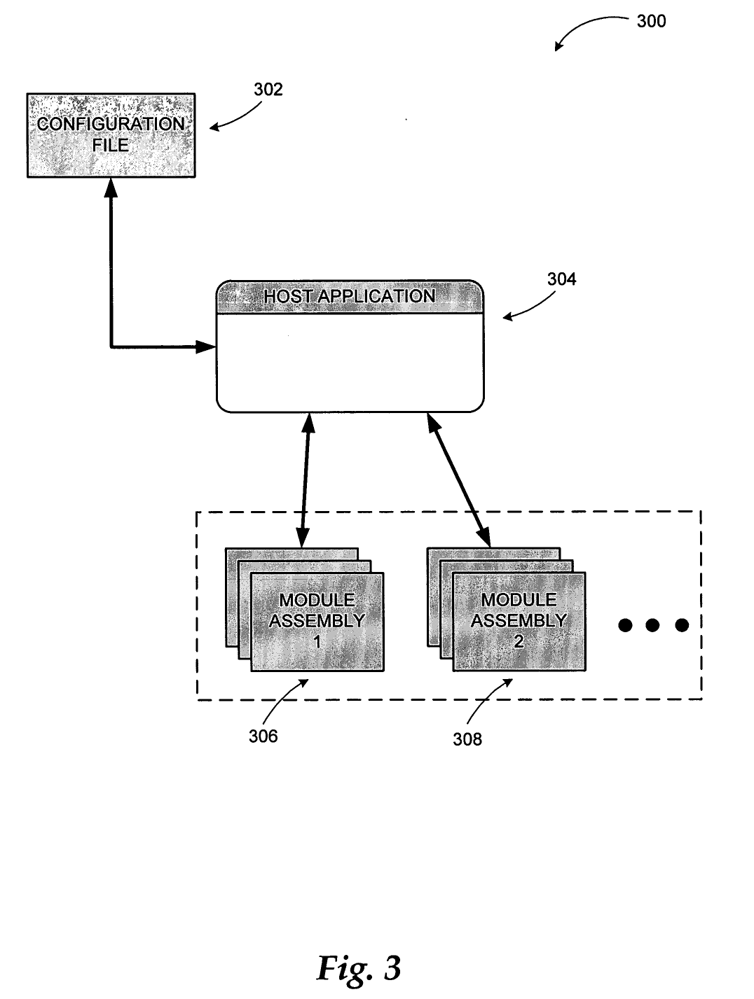

FIG. 3 illustrates example system 300 of interactions between different software components for installation of an operating system.

As mentioned previously, installation of an operating system is a complex task that involves many steps and actions. Typically, a setup program performs three generic tasks: display user interface screens to get user input, perform installation actions (e.g. copying, decompressing, registering of files, determining hardware configurations, and the like), and read data from an unattended file (in unattended mode).

Monolithic applications that are capable of performing these tasks may not be sufficiently flexible to enable customization of an order or content of these tasks. Device manufacturers, software manufacturers, enterprise system administrators, and the like, may desire to customize some or all of the tasks associated with installing an operating system according to their needs.

While enabling third parties to customize the operating system installation process may be a desirable goal, maintaining consistency in the overall setup process is also a significant aspect of designing such a setup program. Presentation of user interface screens, handling of various tasks, handling of installation errors, and the like, are aspects of operating system installation that are designed for efficiency and user satisfaction.

According to one embodiment, installation of an operating system is facilitated by a flexible data-driven hosting application such as host application 304. Host application 304 does not perform any specific actions associated with the installation process itself. Instead, host application 304 reads configuration file 302 and instantiates and calls individual modules from module assemblies 306 and 308. The individual modules are arranged to perform the specific installation tasks such as providing user interface screens, performing setup actions, and others as defined in configuration file 302.

This arrangement is directed to enabling the operating system installation to be reconfigured to perform different sequences of installation actions, additional or fewer actions, customization of user interface screens, and the like.

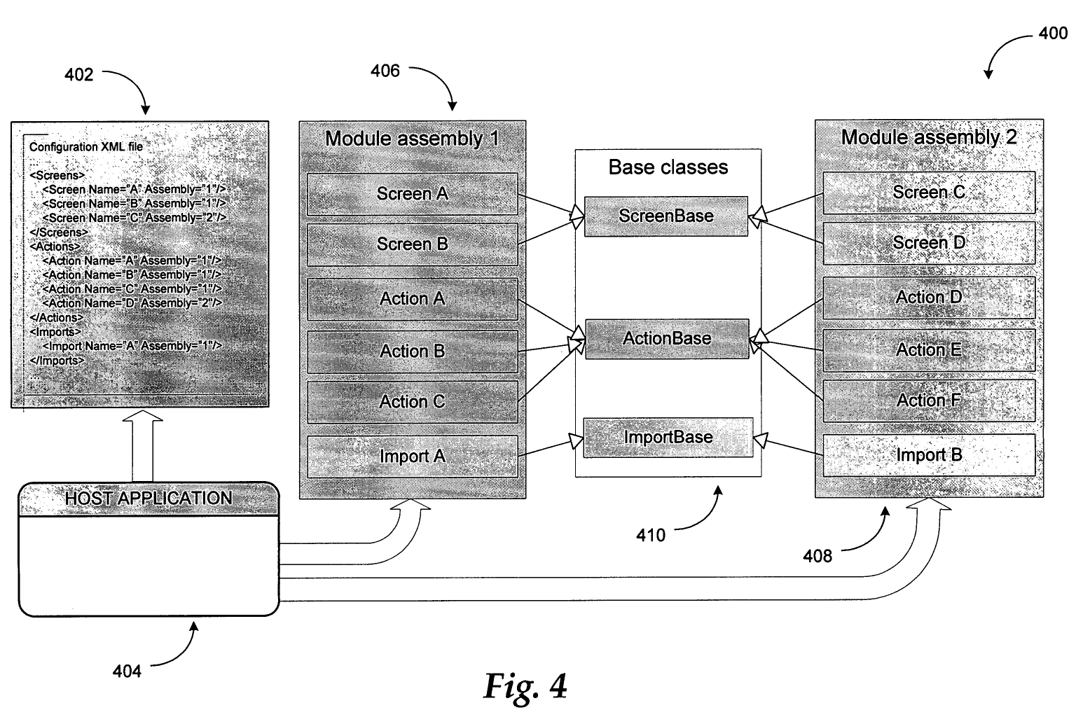

FIG. 4 illustrates diagram 400 of interactions between a configuration file, a host application, and module assemblies during installation of an operating system.

As described above, host application 404 determines from configuration file 402 specific installation tasks and their order, and instantiates and calls modules from module assemblies 406 and 408 to perform those tasks.

In one embodiment, configuration file 402 may be a structured file such as an XML file. Configuration file 402 may define individual tasks, categorized according to their types, by listing their assigned names. In another embodiment, configuration file 402 may include names of modules to perform the tasks and names of module assemblies where the modules reside. While configuration file 402 lists specific example modules, other tasks may also be implemented in other embodiments. Example types of setup modules are screens, actions, and imports.

Screens are panels that are displayed on a setup wizard window controlled by host application 404. A screen module (e.g. Screen A-Screen D) is called when a user enters or leaves the screen. The screen module receives the user input from its own user interface controls. A number of base classes may be defined for screen modules that differ in size, layout, and other parameters.

Actions (e.g. Action A-Action F) are classes that implement specific setup operations like partitioning, formatting, file copy, etc. Actions may derive from the same base class and implement a method such as DoAction. Host application 404 may instantiate action classes in an order defined by the configuration file and call their DoAction methods. In one embodiment, actions may be provided to an interface to report their progress, to show errors, and to add information to a log file.

Imports (e.g. Import A and Import B) are classes that are responsible for importing user data from a data file in an unattended scenario. They are called by the host application and operate in a similar manner to actions.

Commonly used screens, actions, and imports may be grouped into a module assembly such as module assemblies 406 and 408. Module assemblies may be provided to parties customizing their setup program to further simplify the customization process. Modules for basic tasks that are not customized may be grouped in module assemblies, while other module assemblies may be generated comprising customized modules.

Diagram 400 also shows how individual modules are based on specific base classes 410. This allows setup modules to inherit properties and methods that implement common functionality (e.g. logging, user interface), and at the same time compels the modules to implement standardized interfaces enforcing consistency across the installation process.

In one embodiment, the setup program may be implemented as a NET application and the modules as classes. Three example types of setup modules are described above: user interface screens, actions, and imports. However, the invention is not so limited to these modules or application types, and other module and applications may be implemented using the principles described herein.

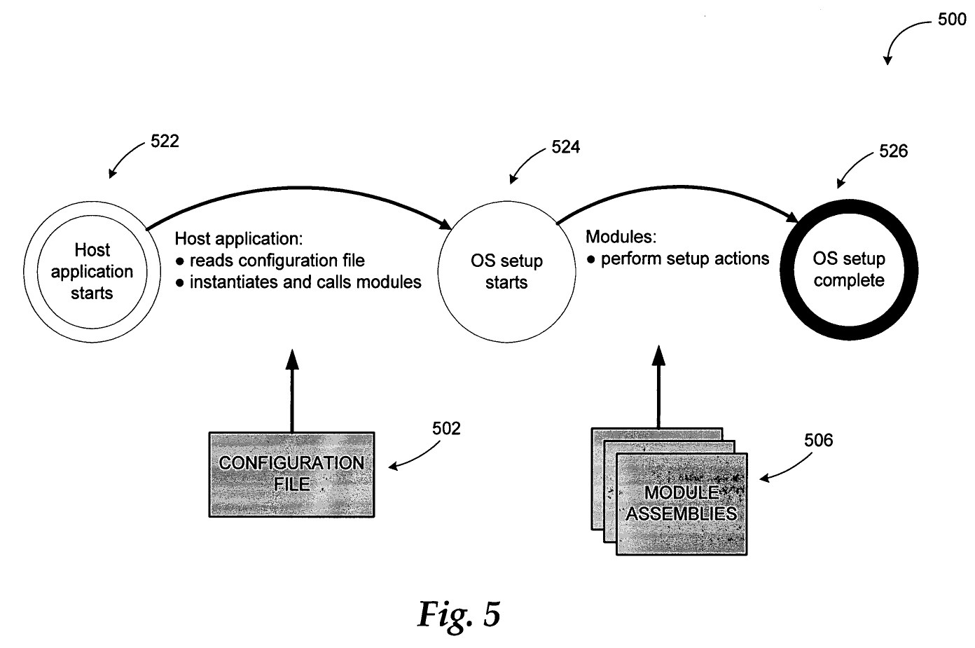

FIG. 5 illustrates diagram 500 of different states and actions during an installation of an operating system.

The installation operation begins at state 522, when the host application starts. The hosting application controls a general flow of setup operation by showing user interface screens and calling setup actions in the right order, and displays progress indicators to user. Specifically, the host application reads specific tasks and their order from configuration file 502, and instantiates and calls modules associated with those tasks from module assemblies 506 to begin the operating system setup at state 524.

Once instantiated and called, the modules perform individual setup tasks such as providing user interface screens for user input, performing actions including copying, formatting, registering configurations, and the like. In some embodiments, the modules may also import data from other files and provide reports on setup progress, errors, and the like.

When all modules defined by configuration file 502 have completed their tasks, the operating system setup is also completed at state 526. In other embodiments, the host application may perform some of the tasks itself and interact with other applications. Where data is to be imported from other files that may reside on other computing devices, the host application may communicate with such computing devices or storage devices.

In interactive mode, the hosting application may first guide a user through the screens and then execute actions. In unattended mode, it may first call imports to read data from unattended file(s) and then call actions. The host application may also perform high-level error handling, control a flow of screens in the setup wizard, and display status and progress. Moreover, the host application may also hold a shared data storage for passing data to and from the modules.

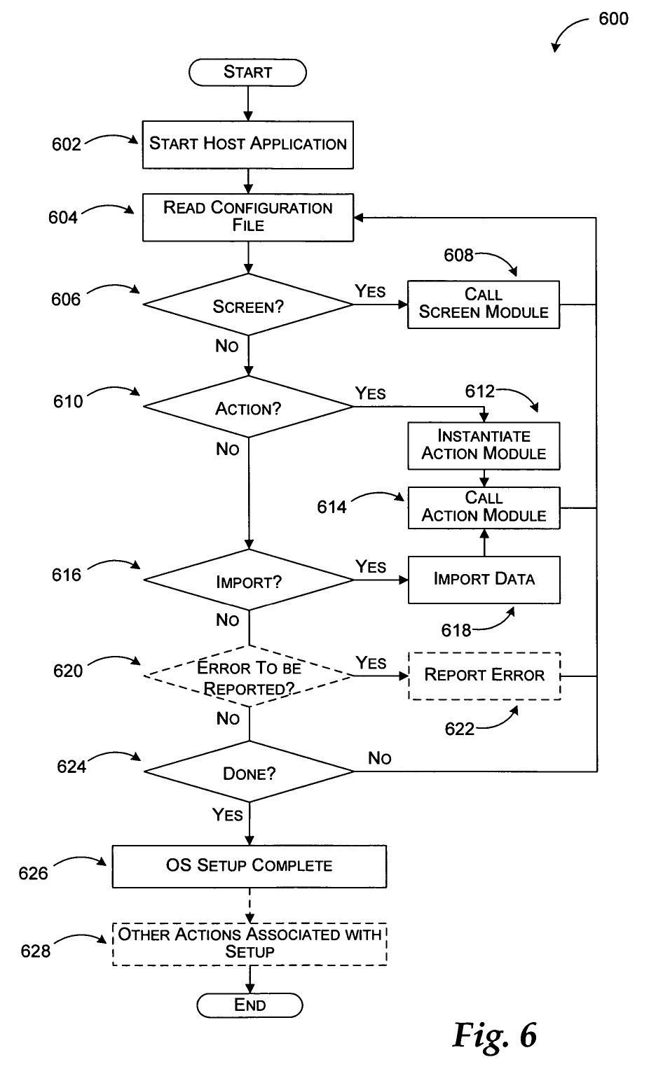

FIG. 6 illustrates a logic flow diagram for a process of installing an operating system.

Process 600 begins at operation 602, where a host application such as the operating system installation application 120 of FIG. 1 is started. Processing advances to operation 604.

At operation 604, the host application determines from a configuration file specific tasks and their order for the installation process. Processing moves from operation 604 to decision operation 606.

At decision operation 606, a determination is made whether the current task in the configuration file is a screen task. If the current task is a screen task, processing proceeds to operation 608, where a screen module is called. In one embodiment, the host application may provide at least some of the screen properties to the called module. In other embodiments, the screen module may inherit some of the properties from user input, custom properties, and the like. The screen module then performs the task and provides a user interface screen for interaction with a user.

Processing returns from operation 608 to operation 604 for further reading of the configuration file. If the determination at decision operation 606 is negative, processing advances to decision operation 610.

At decision operation 610, a determination is made whether the current task in the configuration file is an action. If the current task is an action, processing proceeds to operation 612, where an action module is instantiated. Processing then moves to operation 614, where the action module is called. Similar to the operation with the screen module, the host application may provide at least some of the action properties to the called module. In other embodiments, the action module may inherit some of the properties from user input, custom properties, and the like.

The action module then performs the task such as copying, formatting, partitioning, and the like. In some embodiments, the action module may provide a report on its progress, show errors, and add information to a log file. Processing returns from operation 614 to operation 604 for further reading of the configuration file. If the current task at decision operation 610 is not an action, processing advances to decision operation 616.

At decision operation 616, a determination is made whether the current task in the configuration file is an import task. If the current task is an import task, processing proceeds to operation 618, where an import module is called. The import module retrieves data in unattended mode from an unattended file for copying to the computing device. In one embodiment, the host application may first call imports to read data from unattended file(s) and then call action modules.

Where data is to be imported from other files that may reside on other computing devices, the host application may communicate with such computing devices or storage devices.

Upon completion of the data import, processing advances to operation 614 for actions associated with the imported data. If the determination at decision operation 618 is negative, processing advances to optional decision operation 620.

At optional decision operation 620, a determination is made whether an error is to be reported. If an error is to be reported, processing moves to optional operation 622.

At optional operation 622, the host application reports the error. As described above, the error(s) may be reported in some embodiments by the modules themselves. Processing returns from optional operation 622 to operation 604 for further reading of the configuration file.

If no error is to be reported at optional decision operation 620, processing advances to decision operation 624, where a determination is made whether the reading of the configuration file is complete. If the reading is not complete yet, processing returns to operation 604 for further reading of the configuration file.

If there are no more tasks left in the configuration file, processing proceeds to operation 626. At operation 626, the installation of the operating system is completed. Processing then advances to optional operation 628.

At optional operation 628, additional actions associated with the installation process are performed. Such actions may include high-level error handling, displaying status, and providing a configuration report.

After optional operation 628, processing moves to a calling process for further actions.

The operations included in process 600 are for illustration purposes. Providing an extensible data-driven setup application for operating systems may be implemented by a similar process with fewer or additional steps including performing other tasks, interacting with other applications, using default operations, using other classes, and the like.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method for an extensible data-driven setup application for an operating system, comprising:
determining from a configuration file a task associated with installing the operating system;
instantiating a module associated with the task; and
calling the module associated with the task such that the module performs the task specified by the configuration file.

2. The computer-implemented method of claim 1, wherein the module is one of a number of modules in a module assembly.

3. The computer-implemented method of claim 2, wherein the configuration file includes a listing of the modules and their respective module assemblies.

4. The computer-implemented method of claim 1, wherein the module is one of a screen module that is arranged to provide a user interface screen, an action module that is arranged to perform an action associated with installing the operating system, and an import module that is arranged to import data from a data source.

5. The computer-implemented method of claim 1, wherein the module is based on a base class.

6. The computer-implemented method of claim 1, wherein the configuration file is an extensible Mark-up Language (XML) file.

7. The computer-implemented method of claim 1, further comprising providing at least one property associated with the task to the module.

8. The computer-implemented method of claim 1, wherein at least one property associated with the task is received from a user input.

9. The computer-implemented method of claim 1, further comprising providing at least one of a progress reporting service, an error reporting service, and an information service for a log file.

10. The computer-implemented method of claim 1, wherein the task performed by the module includes one of providing user interface screen for user input, copying files, formatting a storage medium, partitioning a storage medium, registering a configuration, determining a hardware communication, and providing a progress status report.

11. A computer-readable medium having computer instructions for providing a customizable, data-driven operation system installation, the instructions comprising:
listing in a configuration file a predetermined number of tasks associated with installing the operating system;
determining a task from the configuration file;
instantiating a module associated with the task; and
calling the module associated with the task, wherein the module is arranged to perform the task specified by the configuration file.

12. The computer-readable medium of claim 11, wherein the module is one of a number of modules that are combined in one or more module assemblies based on a module type.

13. The computer-readable medium of claim 12, wherein the module type is a base class.

14. The computer-readable medium of claim 13, wherein the base class includes one of a screen class that is arranged to provide a user interface screen, an action class that is arranged to perform an action associated with installing the operating system, and an import class that is arranged to import data from a data source.

15. A system for providing a modular installation of an operating system, the system comprising:
a configuration file configured to include a list defining tasks associated with the installation of the operating system;
a host application configured to determine a task from the configuration file, instantiate a module associated with the task, and call the module; and
a module assembly configured to include at least one module that is arranged to perform the task defined by the configuration file.

16. The system of claim 15, wherein the module is arranged to receive information associated with the task from at least one of a user input, the configuration file, the host application, and another module.

17. The system of claim 15, wherein the host application is further configured to manage communications between modules associated with the tasks defined by the configuration file.

18. The system of claim 17, wherein the host application is further configured to provide additional services that include at least one of a progress reporting service, an error reporting service, an information service for a log file, a user interface service for providing a screen, a copying service, a formatting service, and a partitioning service.

19. The system of claim 15, wherein the configuration file and the module assembly are arranged to be customized without affecting the host application.

20. The system of claim 15, wherein each module in the module assembly is one of a screen module that is arranged to provide a user interface screen, an action module that is arranged to perform an action associated with installing the operating system, and an import module that is arranged to import data from an unattended file, and wherein the modules are grouped according to a module type.
